(19) United States
(12) Patent Application Publication
(10) Pub. No.: US 2014/0010990 A1
(43) Pub. Date: Jan. 9, 2014

(54) DIRECTED ASSEMBLY OF POLY (STYRENE-B-GLYCOLIC ACID) BLOCK COPOLYMER FILMS

(71) Applicants: Paul Franklin Nealey, Madison, WI (US); Shengxiang Ji, Changchun (CN)

(72) Inventors: Paul Franklin Nealey, Madison, WI (US); Shengxiang Ji, Changchun (CN)

(73) Assignee: WISCONSIN ALUMNI RESEARCH FOUNDATION, Madison, WI (US)

(21) Appl. No.: 13/543,681

(22) Filed: Jul. 6, 2012

(51) Int. Cl. B05D 5/00; B32B 33/00

(52) U.S. Cl. 428/119; 427/256

(57) ABSTRACT

Perpendicular nanostructures with small feature dimensions in thin films and related methods of fabrication are provided. In some embodiments, the methods include directed assembly of poly(styrene-b-glycolic acid) (PS-b-PGA), poly(styrene-b-lactic acid) (PS-b-PLA) and other block copolymers containing PGA or a derivative thereof. The block copolymer films can be directed to assemble on chemical patterns such that the nanostructures extend through the thickness of the film, without forming a wetting layer at the free surface. The nanostructures can have sub-10 nm feature dimensions.

### STATEMENT OF GOVERNMENT SUPPORT

This invention was made with government support under 0832760 awarded by the National Science Foundation. The government has certain rights in the invention.

### FIELD OF THE INVENTION

The invention relates to methods of nanofabrication techniques. More specifically, the invention relates to forming nanoscale structures with block copolymers.

### BACKGROUND OF THE INVENTION

Advanced nanoscale science and engineering have driven the fabrication of two-dimensional and three-dimensional structures with nanometer precision for various applications including electronics, photonics and biological engineering. Traditional patterning methods such as photolithography and electron beam lithography that have emerged from the microelectronics industry are limited in the features that can be formed as critical dimensions decrease and/or in fabrication of three-dimensional structures.

### SUMMARY

Perpendicular nanostructures with small feature dimensions in thin films and related methods of fabrication are provided. In some embodiments, the methods include directed assembly of poly(styrene-b-glycolic acid) (PS-b-PGA) and derivatives thereof, including polylactic acid (PLA)-containing block copolymer films. The films can be directed to assemble on chemical patterns such that the nanostructures extend through the thickness of the film, without forming a wetting layer at the free surface. The nanostructures can have sub-10 nm feature dimensions.

One aspect relates to a method of fabricating perpendicular nanostructures in thin films. The method includes depositing a material including a block copolymer on a substrate pattern, the block copolymer including PGA or a derivative thereof, such as PLA. The method further includes ordering the material to form a thin film including phase-separated microdomains that are oriented perpendicularly to the substrate and extend through the thickness of the thin film. In some embodiments, ordering the material includes thermally annealing the material. In some other embodiments, ordering the material can include solvent annealing or other ordering technique. The method may also include selectively removing or functionalizing one or more phases of the thin film.

In some embodiments, the block copolymer further includes polystyrene (PS) and/or polymethyl methacrylate (PMMA) or a derivative thereof. The block copolymer can be a diblock, a triblock, or a higher order block copolymer. The domain size can be less than 20 nm and in some embodiments, less than about 10 nm.

Another aspect relates to a method including providing a thin film on a substrate, the thin film including phase-separated microdomains that are oriented perpendicularly to a substrate and extend through the thickness of the thin film, with the block copolymer including a block of PGA or a derivative thereof. The method can include removing this block by hydrolysis or other appropriate method.

Another aspect relates to a thin film structure comprising phase-separated microdomains of a block copolymer, the microdomains oriented perpendicularly to an underlying substrate and extending through the thickness of the thin film, wherein the block copolymer includes PGA or a derivative thereof, such as PLA. In some embodiments, the substrate includes a surface pattern. The phase-separate microdomains can be registered with the surface pattern. The correspondence of the microdomains to the substrate pattern can be 2:1 or greater. The domain size can be less than 20 nm and in some embodiments, less than about 10 nm.

Another aspect relates to nanoimprint templates, patterned media and related methods of fabrication. These and other features of the invention are described further below with reference to the drawings.

### BRIEF DESCRIPTION OF THE DRAWINGS

FIG. 1 shows an example of ideal phase behavior of diblock copolymers.

FIGS. 2A and 2B show examples of directed assembly of lamellar and cylindrical ordered domains.

FIG. 3 shows an example of a process flow for fabricating block copolymer (BCP) thin film structures.

FIG. 4 shows an SEM image of a top view of a 30-nm thick cylinder-forming PS-b-PLA film assembled on PS-r-PMMA brushes.

FIG. 5A shows an SEM image of a top view of a 30-nm thick cylinder-forming PS-b-PLA film assembled on PMMA homopolymer brushes.

FIG. 5B shows an SEM image of a top view of an 80-nm thick cylinder-forming PS-b-PLA film assembled on PMMA homopolymer brushes.

FIG. 6 shows an SEM image of a top view of an 80-nm thick cylinder-forming PS-b-PLA film assembled on PS-r-PMMA brushes.

FIG. 7 shows an SEM image of a top view of an 80-nm thick cylinder-forming PS-b-PLA film assembled on a chemically patterned substrate.

FIG. 8 shows an SEM image of a top view of a 30-nm thick lamella-forming PS-b-PLA film assembled on PS-r-PMMA brushes.

FIG. 9 shows a SEM image of a top view of a 40-nm lamella-forming PS-b-PLA film assembled on a chemically patterned substrate.

FIG. 10 is an example of a process flow for creating and using a BCP thin film composition.

FIG. 11 is illustrates an example of a nanoimprint process using a template according to various embodiments.

### DETAILED DESCRIPTION

Reference will now be made in detail to specific embodiments of the invention. Examples of the specific embodiments are illustrated in the accompanying drawings. While the invention will be described in conjunction with these specific embodiments, it will be understood that it is not intended to limit the invention to such specific embodiments. On the contrary, it is intended to cover alternatives, modifications, and equivalents as may be included within the spirit and scope of the invention. In the following description, numerous specific details are set forth in order to provide a thorough understanding of the present invention. The present invention may be practiced without some or all of these specific details. In other instances, well known process operations have not been described in detail in order not to unnecessarily obscure the present invention.

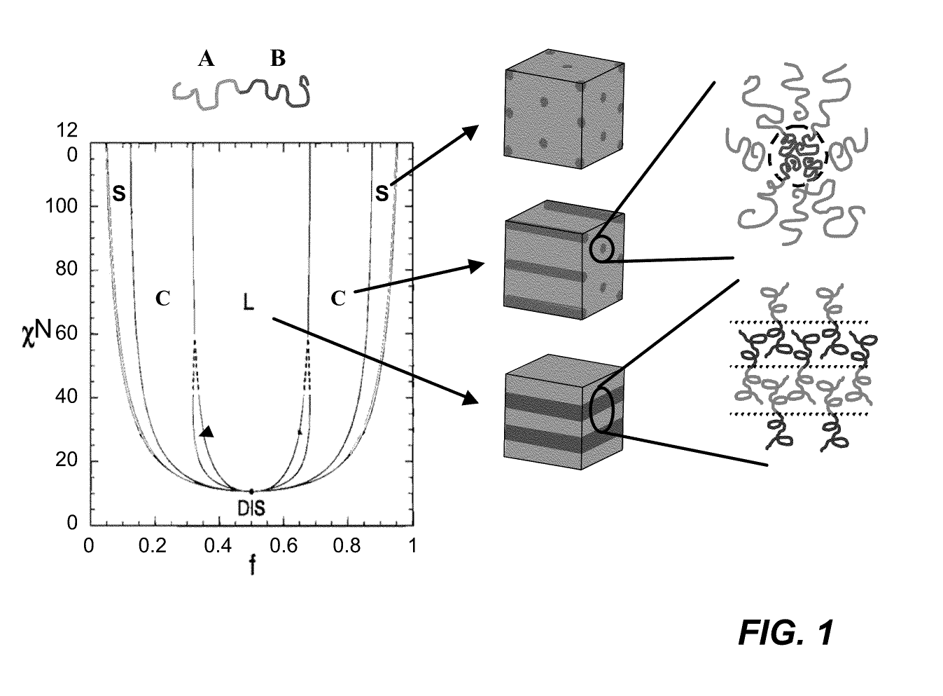

Provided herein are methods of directed self-assembly of block copolymers on patterns, and the resulting thin films, structures, media or other compositions. Self-assembling materials spontaneously form structures at length scales of interest in nanotechnology. Block copolymers (also referred to herein as BCPs) are a class of polymers that have two or more polymeric blocks. The structure of diblock copolymer AB, also denoted A-b-B, may correspond, for example, to AAAAAAA-BBBBBBBB. FIG. 1 shows theoretical phase behavior of an A-b-B diblock copolymer. The graph in FIG. 1 shows, χN (where χ is the Flory-Huggins interaction parameter and N is the degree of polymerization) as a function of the volume fraction, f, of a block (A) in a diblock (A-b-B) copolymer. χN is related to the energy of mixing the blocks in a diblock copolymer and is inversely proportional to temperature. FIG. 1 shows that at a particular temperature and volume fraction of A, the diblock copolymers microphase separate into domains of different morphological features (also referred to as microdomains). As indicated in FIG. 1, when the volume fraction of either block is around 0.1, the block copolymer will microphase separate into spherical domains (S), where one block of the copolymer surrounds spheres of the other block. As the volume fraction of either block nears around 0.2-0.3, the blocks separate to form a hexagonal array of cylinders (C), where one block of the copolymer surrounds cylinders of the other block. And when the volume fractions of the blocks are approximately equal, lamellar domains (L) or alternating stripes of the blocks are formed. Representations of the cylindrical and lamellar domains at a molecular level are also shown. Domain size typically ranges from 2 nm or 3 nm to 50 nm. The phase behavior of block copolymers containing more than two types of blocks (e.g., A-b-B-b-C), also results in microphase separation into different domains. The size and shape of the domains in the bulk depend on the overall degree of polymerization N, the repeat unit length a, the volume fraction f of one of the components f, and the Flory-Huggins interaction parameter, χ.

A block copolymer material may be characterized by bulk lattice constant or period Lₒ. For example, a lamellar diblock copolymer film has a bulk lamellar period or repeat unit, Lₒ, equal to the width of two adjacent stripes. For cylindrical and spherical domain structures, the periodicity Lₒ of the bulk domain structures can be characterized by a center-to-center distance between the cylinders or spheres, e.g., in a hexagonal array. While the FIG. 1 shows an example of phase behavior of a diblock copolymer for illustrative purposes, the phase behavior of triblock and higher order block copolymers also can results in microphase separation into different architectures.

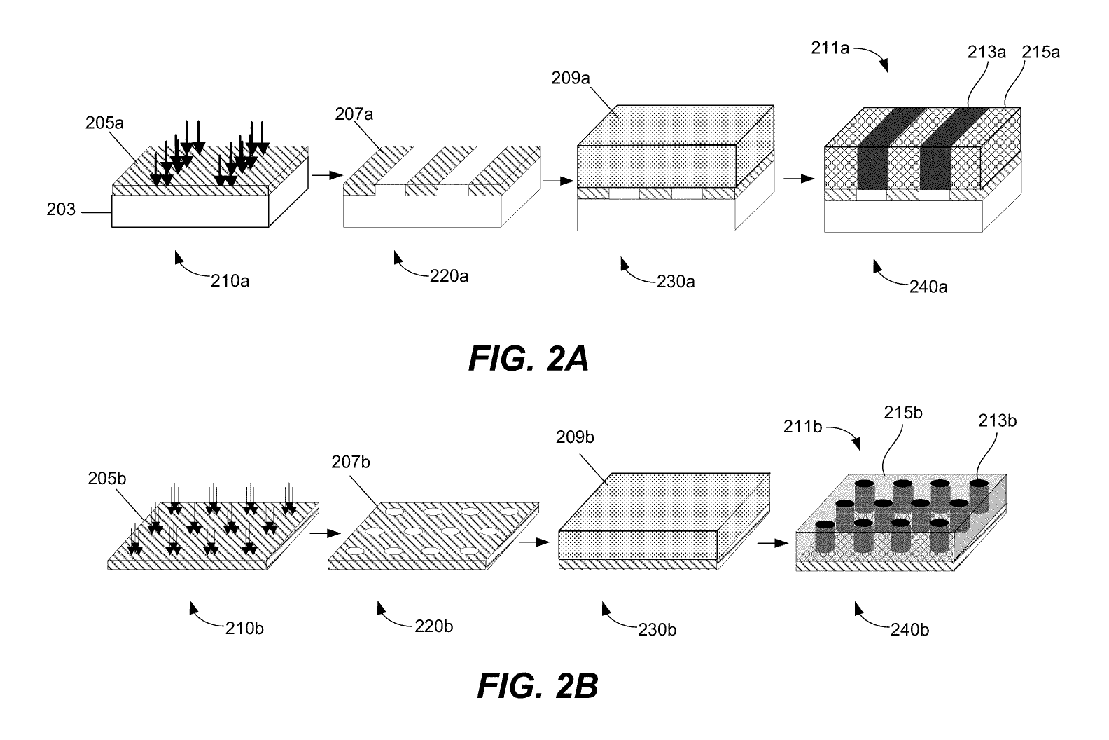

FIGS. 2A and 2B show examples of directed assembly of lamellar (FIG. 2A) and cylindrical (FIG. 2B) ordered domains. Patterning of layers 205a and 205b is indicated at 210a and 210b, respectively, with the arrows representing radiation appropriate to pattern a layer, such as x-ray radiation, extreme ultraviolet (EUV) radiation or electron beam radiation. Layers 205a and 205b, which can be referred to as patternable layers or imaging layers, are layers of material that can be selectively altered to create a chemical pattern. In one example, a layer of polystyrene (PS) brushes anchored to a surface is used as an imaging layer. FIG. 2A shows layer 205a on a substrate 203, which can be a silicon (Si) wafer or other appropriate substrate. Patterning can include use of a resist as generally known to one having ordinary skill in the art to expose regions of the patternable layer to form the desired pattern, followed by chemical modification of the exposed regions; for example, exposed regions of a PS brush layer can be oxidized. Chemically patterned surfaces 207a and 207b are indicated at 220a and 220b, respectively, with surface 207a patterned with alternating stripes and surface 207b patterned with an array of spots. Block copolymer material 209a and 209b is deposited on the chemically patterned surfaces 207a and 207b, respectively, as indicated at 230a and 230b. The block copolymer material 209a and 209b is then induced to undergo microphase separation.

The chemically patterned surfaces 207a and 207b can direct the assembly of the block copolymer material 209a and 209b such that the phase-separated domains are oriented perpendicular to the underlying surface and registered with the chemical pattern. The assembled phase-separated thin films 211a and 211b are shown at 240a and 240b, respectively. Thin film 211a includes lamellae of first polymer 213a and second polymer 215a aligned with the stripes of the underlying chemical pattern. Thin film 211b includes cylinders of a first polymer 213b in a matrix of a second polymer 215b, with the cylinders and matrix aligned with the underlying chemical pattern.

Periodic patterns formed on substrates or in thin block copolymer films may also be characterized by characteristic lengths or spacings in a pattern. Lₛ is used herein to denote the period, pitch, lattice constant, spacing or other characteristic length of a pattern such as surface pattern. For example, a lamellar period Lₛ of a two-phase lamellar pattern may be the width of two adjacent stripes. In another example, a period Lₛ of an array of spots may be the center-to-center distance of spots.

As discussed above with respect to FIG. 1, microphase separation of an A-b-B BCP and the resulting structure depends on the relative concentrations f_{A} and f_{B} of the component polymers, the degree of polymerization N, and the Flory-Huggins interaction parameter, χ. χ is related to the energy of mixing the blocks in a block copolymer and generally inversely proportional to temperature. Equation 1 below gives χ for an A-b-B BCP, with ε_{AB}, ε_{AA} and ε_{BB} the pairwise energies between the components, k_{B} the Boltzmann constant, and T temperature.

χ_{(A-b-B)}=[ε_{AB}−½(ε_{AA}+ε_{BB})]/k_{B}T (Equation 1)

χ is higher and microphase separation is easier for BCPs having dissimilar component blocks. Domain sizes and characteristic lengths of block copolymers can also depend on the interaction parameter, χ, of a BCP, with BCPs having higher χ able to form smaller domains.

Surface energy, as used herein, refers to energy at the surface between a condensed and non-condensed phase, such as a solid block copolymer thin film or block copolymer film in the melt and a gas or vacuum. Interfacial energy, as used herein, refers to energy at the surface between two condensed phases, such as a solid block copolymer thin film or block copolymer thin film in the melt and a liquid or solid. Surface or interfacial energies of the blocks of a BCP system that are commensurate can allow the BCP system to assemble with non-preferential wetting of domains of different blocks at a surface or interface. Different surface energies of the component polymers at a free surface of a BCP thin film can result in a wetting layer at this surface. For example, thermal annealing of a PS-b-P2VP thin film can result in a thin layer PS on the assembled PS-b-P2VP film due to the smaller surface tension of PS. An additional etching may remove the top layer, which may alter the surface properties and cause the decrease of the pattern aspect ratio. PS-b-PMMA facilitates generating perpendicularly oriented microdomains through a film thickness; however, the relatively low χ can limit the smallest domain size that can be achieved by thermal annealing to about 25 nm. To date, high χ BCP systems have resulted in preferential wetting at the surface. For example, poly(styrene-b-dimethylsiloxane) (PS-b-PDMS) and poly(styrene-b-ethylene oxide) (PS-b-PEO) are high χ materials, which result in preferential wetting of one domain at the surface under thermal annealing and even solvent annealing conditions. This is likely due to a high surface energy difference between the blocks.

Embodiments described herein relate to directed assembly of BCP materials that include PS-b-PGA or its derivatives, such as PS-b-PLA. These are high χ systems that can form sub-10 nm domains. For example, it has been found that, despite having a high interaction parameter and unlike other high χ systems, PS-b-PLA can be directed to assemble on patterns yielding perpendicular structures without a wetting layer. Without being bound by a particular theory, it is believed that this indicates that PS and PLA have similar surface energies.

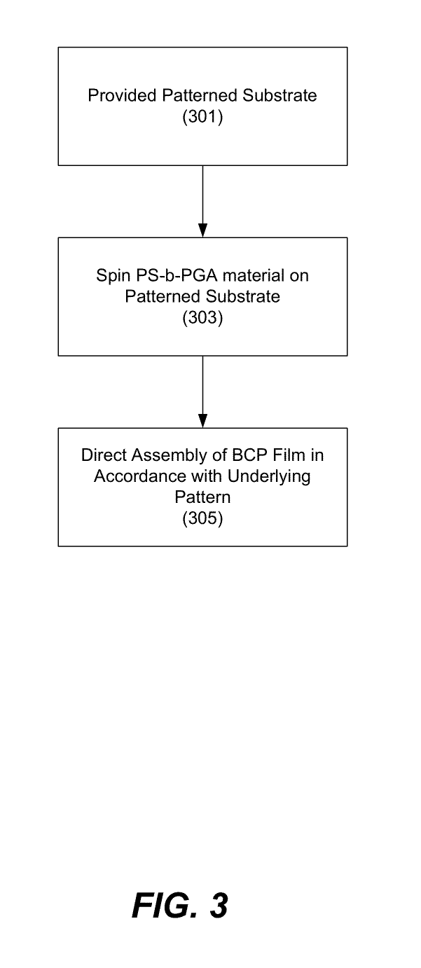

FIG. 3 is a flow diagram showing operations in a method of directed self-assembly of a BCP material according to certain embodiments. First, a patterned substrate is provided at block 301. The substrate can be patterned with regions of different chemical compositions. Schematic examples of patterned substrates are shown at 220a and 220b in FIGS. 2A and 2B, discussed above. The substrate pattern will direct the assembly of the BCP thin film and so corresponds to the desired morphology of the thin film. In some embodiments, the substrate pattern period Lₛ is commensurate to a period Lₒ of the BCP material to be deposited on the pattern. This is discussed further below.

A PS-b-PGA material is then spun on (or otherwise deposited) on the patterned substrate at block 303. Schematic examples of unassembled BCP material on patterned substrates are shown at 230a and 230b in FIGS. 2A and 2B. The structure of PS-b-PGA is given according Formula I:

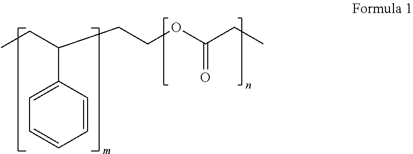

with m styrene repeat units and n glycolic acid repeat units. (BCPs according to Formula I, or polymers according to any Formula herein, can have any appropriate terminal group on each free end of the block or blocks.)

The PS-b-PGA material includes a BCP including polystyrene and poly(glycolic acid) or derivatives of one or both of these component polymers. Poly(glycolic acid) may be derivatized with the addition of one or more R groups, as shown in Formula 2, below:

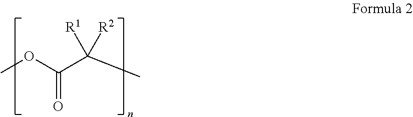

where each or R¹ and R² is, independent of the other, one of H, C₁₋₁₀ alkyl, C₁₋₁₀ alkenyl, C₁₋₁₀ alkynyl, or aryl; or R¹ and R², together with the carbon atom to which they are attached form a C₃₋₇ cycloalkyl. In some embodiments, each of R¹ and R² is H or C₁₋₃ alkyl. A polymer according to Formula 2 can be used in various BCPs. In some embodiments, the BCP includes PLA, for example, the BCP can be PS-b-PLA, the structure of which is given below:

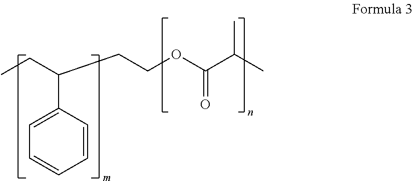

PS-b-PLA can microphase separate into domains having feature sizes as low as about 5 nm. Feature size refers to the smallest dimension of a feature in a BCP film, e.g., the width of a lamella or the diameter of cylinder. Another example of a BCP that can be used is polystyrene-b-poly(hydroxyisobutyric acid) (PS-b-PIBA), the structure of which is given below:

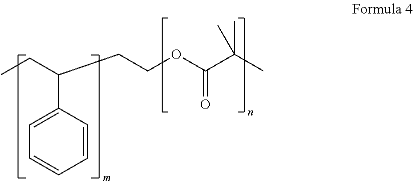

In certain embodiments, the PGA, PLA or PIBA or other block can be derivatized as shown in Formula 2 to adjust its surface energy relative to another block in the BCP. According to various embodiments, all or only a fraction of monomers in a block can be derivatized according to Formula 2. Polystyrene can also be derivatized, for example, by the addition of one or more alkyl groups on all or a portion of styrene monomers in the BCP.

In certain embodiments, polyacrylates may be used in place of PS in any glycolic acid-containing or derivative of glycolic acid-containing BCP, including poly(methyl methacrylate)-b-poly(lactic acid) (PMMA-PLA), an example of which is shown below:

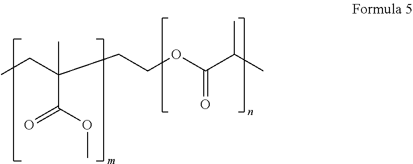

with m methyl methacrylate repeat units and n lactic acid repeat units. Further examples include PMMA-PGA and PMMA-PIBA. Polyacrylates include poly(methyl acrylate), poly(ethyl acrylate), poly(propyl acrylate), poly(t-butyl acrylate), poly(ethyl methacrylate), poly(propyl methacrylate) and poly(t-butyl methacrylate).

Still further, in some embodiments a modified polyisoprene (PI) may be used in place of PS in any glycolic acid-containing or derivative of glycolic acid-containing BCP. Modified PI is described in U.S. Provisional Patent Application No. 61/513,343, incorporated by reference herein. In some embodiments, a fraction of the PI block is modified with epoxy functional groups.

The PS-b-PGA material can include diblock copolymers or triblock or higher order copolymers having PS and PGA or derivatives thereof as component polymers. For example, in some embodiments, a PLA-PS-PLA triblock, the structure of which is shown below, is used.

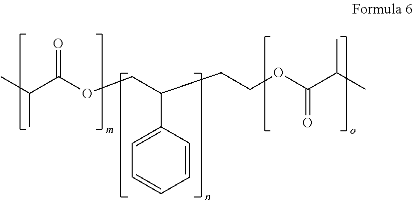

with n styrene repeat units, and m lactic acid repeat units of the first lactic acid block and o lactic acid repeat units of the second lactic acid block; m and o can be the same or different.

Returning to FIG. 3, the BCP film is directed to assemble in accordance with the underlying pattern (305). Block 305 involves inducing microphase separation in the BCP, with the chemical difference of the patterned regions providing a driving force to register the microdomains with the pattern. Block 305 can involve thermally annealing the material spun on in block 303 above its glass transition temperature. Other methods of inducing microphase separation, such as by application of electric force, can be used. In some embodiments, the block 305 can involve solvent annealing, though one advantage that solvent annealing has over thermal annealing for many systems (lack of wetting layer) does not apply to PS-b-PGA, PS-b-PLA and other systems that do not form a wetting layer when thermally annealed. Solvent annealing of BCP materials on patterned substrates is discussed further in U.S. patent application Ser. No. 13/367,337, titled “Solvent Annealing Block Copolymers on Patterned Substrates,” incorporated by reference herein.

According to various embodiments, the BCP thin film as assembled does not include a wetting layer, with the microdomains extending through the entire thickness of the film. The phenomena can occur for arbitrary thick films, at least before a thickness at which the material with revert to a bulk morphology. In some embodiments, the film thickness can be about 80 nm or higher, with microdomains oriented perpendicular to the substrate extending through the thickness.

Parameters

The following are examples of substrates, patterning techniques, patterns, and block copolymer materials that may be used in accordance with certain embodiments.

Substrate

Any type of substrate may be used. In semiconductor applications, wherein the block copolymer film is to be used as a resist mask for further processing, substrates such as silicon or gallium arsenide may be used. For patterned media applications, a master pattern for patterned media may be made on almost any substrate material, e.g., silicon, quartz, or glass.

According to various embodiments, the substrate may be provided with a thin film or imaging layer thereon. The imaging layer may be made of any type of material that can be patterned or selectively activated. In a certain embodiment, the imaging layer comprises a polymer brush or a self-assembled monolayer. Examples of self-assembled monolayers include self-assembled monolayers of silane or siloxane compounds, such as self-assembled monolayer of octadecyltrichlorosilane.

In certain embodiments, the imaging layer or thin film to be patterned is a polymer brush layer. In certain embodiments, the polymer brush may include one or more homopolymers or copolymers of the monomers that make up the block copolymer material. For example, a polymer brush of at least one of styrene and methyl methylacrylate may be used where the block copolymer material is PS-b-PMMA. One example of a polymer brush to be used in a thin film is hydroxyl-terminated polystyrene (PS-OH). In some embodiments, a pattern may be provided without an underlying substrate, for example as an unsupported polymer film.

Patterning

Patterns may be formed by any method, including all chemical, topographical, optical, electrical, mechanical patterning and all other methods of selectively activating a substrate. A chemically patterned surface can include, for example, patterned polymer brushes or mats, including copolymers, mixtures of different copolymers, homopolymers, mixtures of different homopolmyers, block oligomers, and mixtures of different block oligomers. In embodiments where a substrate is provided with an imaging layer (such as a self-assembled monolayer or polymer brush layer) patterning the substrate may include patterning the imaging layer. In some embodiments, patterning may include forming background regions that are non-preferential or weakly preferential to the component blocks of the BCP.

A substrate may be patterned by selectively applying the pattern material to the substrate. In some embodiments, a resist can be patterned using an appropriate method. The substrate patterning may include top-down patterning (e.g. lithography), bottom-up assembly (e.g. block copolymer self-assembly), or a combination of top-down and bottom-up techniques. In certain embodiments, the substrate is patterned with x-ray lithography, extreme ultraviolet (EUV) lithography or electron beam lithography. In certain embodiments, a chemically patterned surface can be prepared using a molecular transfer printing method as disclosed in U.S. Pat. No. 8,133,341, titled “Molecular Transfer Printing Using Block Copolymers,” incorporated by reference herein.

Pattern

Substrate surface patterns, or other patterns that direct the assembly of block copolymer (as well as the block copolymer material used) affect self-assembled domains that result from the processes described above. The surface pattern and the BCP film deposited on it can be chosen to achieve the desired pattern in the block copolymer film. In certain embodiments, the pattern period Lₛ is commensurate with the corresponding bulk period Lₒ of the BCP material. In certain embodiments, the BCP directed assembly systems can tolerate a deviation of about 10% between Lₛ and Lₒ such that the pattern can direct the assembly of the BCP, with the BCP replicating the underlying pattern. Certain BCP systems can tolerate greater deviations; for example, ABA triblock copolymers having an Lₒ such that 0.9Lₒ≦Lₛ≦1.55Lₒ (0.65Lₛ≦Lₒ≦1.1Lₛ) can be directed to assemble by the underlying pattern, replicating the underlying pattern. This is described in U.S. Provisional Patent Application No. 61/606,292, incorporated by reference herein.

In some embodiments, directed assembly can involve density multiplication of the substrate pattern. Density multiplication refers the density of features in an assembled film being greater than that of the patterned substrate. The substrate pattern can have a period Lₛ commensurate with nLₒ with n equal to an integer greater than 1. For example, Lₛ may be nLₒ+/−0.1 nLₒ. In certain embodiments, there is a 1:1 correspondence between the number of features patterned on the substrate (by e-beam lithography or other technique) and the number of features in the self-assembled block copolymer film. In other embodiments, there may be a 1:2, 1:4 or other correspondence, with the density of the substrate pattern multiplied as described in US 2009-0196488, titled “Density Multiplication And Improved Lithography By Directed Block Copolymer Assembly” incorporated by reference herein. It should be noted that in certain cases, the 1:1 correspondence (or 1:2, etc.) might not be exactly 1:1 but about 1:1, e.g., due to imperfections in the substrate pattern.

The directed assembly may or may not be epitaxial according to various embodiments. That is, in certain embodiments, the features as defined by the block copolymer domains in the block copolymer film are located directly above the features in the chemical contrast pattern on the substrate. In other embodiments, however, the growth of the block copolymer film is not epitaxial. In these cases, the chemical contrast (or other substrate pattern) may be offset from the self-assembled domains. Even in these cases, the block copolymer domains are typically spatially registered with the underlying chemical pattern, such that the location of a block copolymer domain in relation to a location of a patterned feature is precisely determined. In some embodiments, registered block copolymer domains are aligned such that an interface between domains overlies an interface between the adjacent pattern features. In some other embodiments, registered domains may be offset from and/or differently sized than the underlying pattern features.

In certain embodiments, the pattern corresponds to the geometry of the bulk copolymer material. For example, hexagonal arrays of cylinders are observed bulk morphologies of certain block copolymers, and a pattern can include a hexagonal array. However, in other embodiments, the substrate pattern and the bulk copolymer material do not share the same geometry. For example, a block copolymer film having domains of square arrays of cylinders may be assembled using a material that displays hexagonal arrays of cylinders in the bulk.

The individual features patterned on the substrate may be smaller than or larger than the mean feature size of the block copolymer domains (or the desired feature size). In certain embodiments, the pattern has at least one dimension within an order of magnitude of a dimension of one domain in the block copolymer material.

In some embodiments, a pattern may include a varying effective pattern period. In some embodiments, a pattern may be characterized as having a pattern period Lₛ that represents that length scale of uniformly spaced features that may dominate or be a major part of a pattern. For example, a pattern period Lₛ in the example depicted at 220a in FIG. 2A is the width of portions of adjacent stripes. Likewise, a pattern period Lₛ in the example depicted at 220b in FIG. 2B is the center-to-center distance of spots. Irregular features such as bends and t-junctions may give rise to effective pattern periods that differ from the pattern period Lₛ. In some embodiments, a pattern may not have any one length scale that dominates the pattern, but have a collection of features and associated effective pattern periods. In some embodiments, the effective pattern period L_{s-eff} may vary by up to about 30%, 40%, 50% or 100% or greater across the pattern. Further examples of patterns are described in US-2006-0134556, titled “Methods And Compositions For Forming Aperiodic Patterned Copolymer Films” and in US-2008-0299353, titled “Methods And Compositions For Forming Patterns With Isolated Or Discrete Features Using Block Copolymer Materials,” both of which are incorporated by reference herein.

BCP System

The BCP system can include a diblock, triblock, or higher order BCP containing polystyrene blocks or derivatives thereof and polyglycolic acid blocks or derivatives thereof. In some embodiments, the BCP system can include a diblock, triblock, or higher order BCP containing polyacrylate blocks and polyglycolic acid blocks or derivatives thereof. In some embodiments, the BCP system can include a BCP containing polystyrene or a polyacrylate and a block including a poly(alpha hydroxyl acid) such as polylactic acid.

Examples of BCPs that can be used according to various embodiments include PS-PLA, PS-PLA-PS, PMMA-PLA, PMMA-PLA-PMMA, PLA-PS-PLA, PS-PLA-PMMA, PS-PGA, PS-PGA-PS, PMMA-PGA, PMMA-PGA-PMMA, PGA-PS-PGA, PS-PGA-PMMA, PS-PIBA, PS-PIBA-PS, PMMA-PIBA, PMMA-PIBA-PMMA, PIBA-PS-PIBA, and PS-PIBA-PMMA. Further examples of glycolic acid derivatives and other blocks that can be used in BCPs in the methods described herein are given above. D- and/or L-monomers can be used. For example, the lactic acid or lactic acid derivative block can be amorphous (formed from D- and L-monomers) or crystallizable (formed from L- or D-monomers). If crystallizable, the BCP is allowed to microphase separate prior to crystallization.

Synthesis of PS-PLA block copolymers is described in Zalusky et al. Ordered Nanoporous Polymers from Polystyrene-Polylactide Block Copolymers, J. Am. Chem. Soc., Vol. 124, No. 43, 12761-12773(2002). A generalized synthesis of polystyrene-containing diblock copolymers is provided below.

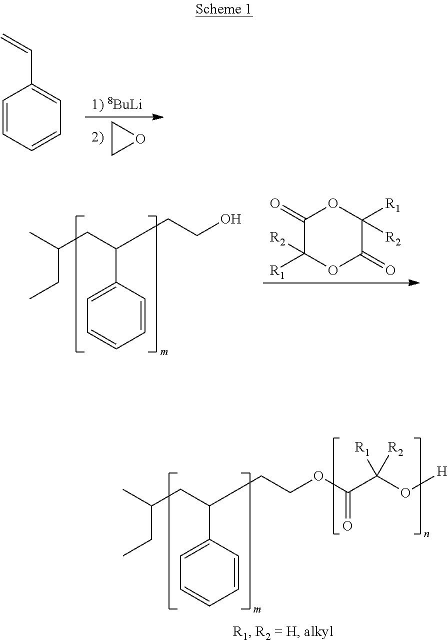

An example of a triblock synthesis is given below:

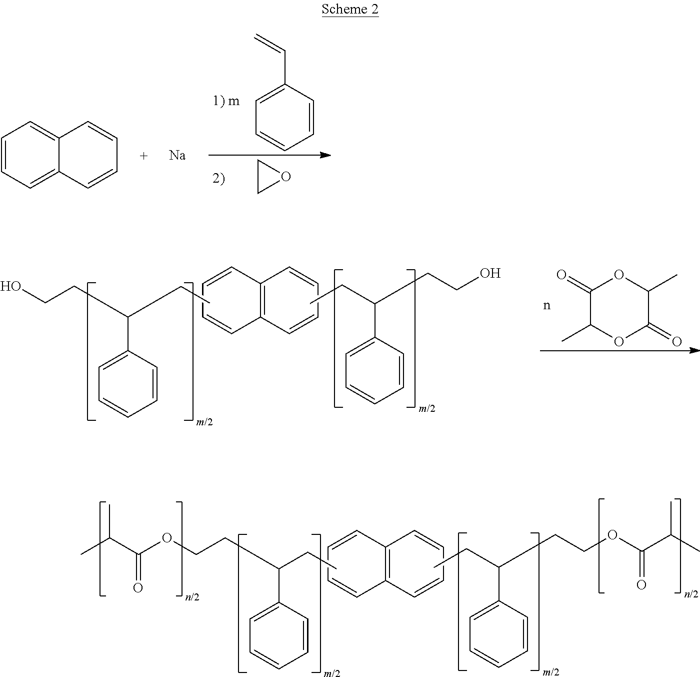

One having ordinary skill in the art will understand from the above schemes how to synthesize the BCP's described herein.

Block copolymer materials having various bulk morphologies may be used, including lamellae-forming block copolymers, cylinder-forming block copolymers, and sphere-forming block copolymers. Asymmetric and symmetric block copolymers can be used. The block copolymer material may include one or more additional block copolymers. In some embodiments, the material may be a block copolymer/block copolymer blend.

The block copolymer material may also include one or more homopolymers. The block copolymer material may include any swellable material. Examples of swellable materials include volatile and non-volatile solvents, plasticizers and supercritical fluids. In some embodiments, the block copolymer material contains nanoparticles dispersed throughout the material. The nanoparticles may be selectively removed.

The size of the blocks can be any appropriate size that will phase separate. In some embodiments, the molecular weight Mₙ of each block may be as low as about 5K. Smaller blocks can be used if they can undergo phase separation.

### EXPERIMENTAL

### EXAMPLE 1

### Self-Assembly of Cylinder-Forming PS-b-PLA on Homogenous Brushes

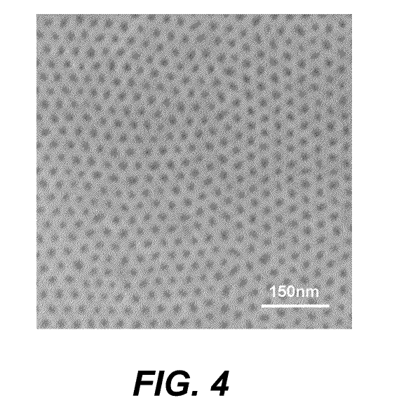

A PS-b-PLA BCP (Mₙ=21K PS−9K PLA; Lₒ of about 29.9 nm) film was deposited on a surface of PS-r-PMMA (60% styrene/40% methyl methacrylate) random copolymer brushes. The BCP was thermally annealed at 190° C. for 12 hrs. Film thickness was about 30 nm. FIG. 4 is a close-up SEM image of the assembled film. The PS-b-PLA film assembled into perpendicular cylinders of PLA in a matrix of PS over an arbitrarily large area. This indicates that the PS-r-PMMA brush provided non-preferential wetting for the PS-b-PLA BCP. No wetting layer was observed, with the cylinders extending through the entire film thickness of 30 nm. Without being bound by any particular theory, it is believed that this may evidence that PS and PLA have nearly equal surface energies.

PS-r-PMMA also provides a non-preferential surface for PS-b-PMMA, indicating that PMMA, PS, and PLA act similarly—both at the free surface and at brush/BCP interface. This suggests that PMMA- and PLA-containing BCPs may behave similarly to PS- and PLA-containing BCPs and can be used to assemble thin films without a wetting layer.

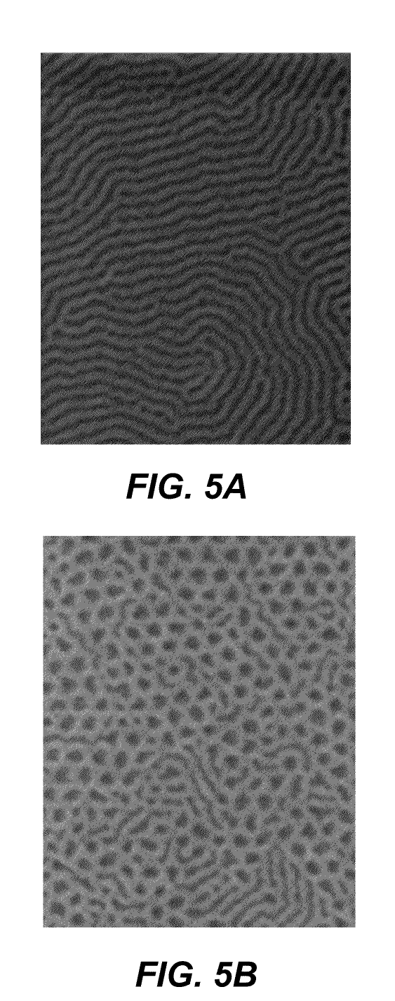

PS-b-PLA BCP (Mₙ=21K-9K; Lₒ of about 29.9 nm) films were deposited on surfaces of PMMA homopolymer brushes and thermally annealed at 190° C. for 3 hrs. Films of about 30 nm and 80 nm were imaged. FIG. 5A is a close-up SEM image of the assembled 30 nm thick film. FIG. 5B is a close-up SEM image of the assembled 80 nm thick film. The image in FIG. 5A shows microdomains of cylinders oriented parallel to the substrate. Without being bound by a particular theory, it is believed that the PLA wets the PMMA brush preferentially, driving the assembly of parallel rather than perpendicular cylinders. The image in FIG. 5B shows a honeycomb-type structure. It is possible that the 80 nm assembled film includes a layer of parallel cylinders (as in FIG. 5B), with the blocks attempting to “turn” to get to a non-preferential free surface, forming the honeycomb-type structure.

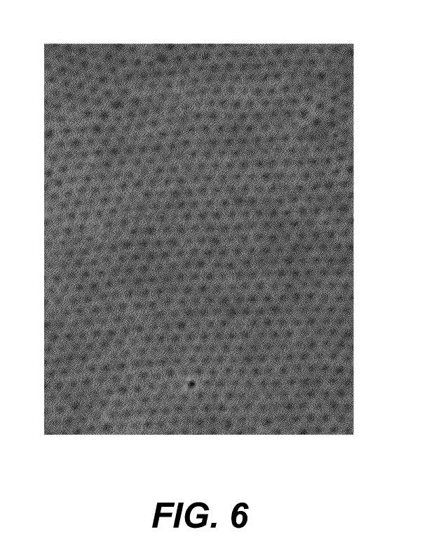

A PS-b-PLA BCP (Mₙ=21K-9K; Lₒ of about 29.9 nm) film was deposited on a surface of PS-r-PMMA (40% styrene/60% methyl methacrylate) random copolymer brushes. The BCP was thermally annealed at 190° C. for 3 hrs. Film thickness was about 80 nm. FIG. 6 is a close-up SEM image of the assembled film. The PS-b-PLA film assembled into a hexagonal array of perpendicular cylinders of PLA in a matrix of PS over an arbitrarily large area. This is similar to the result shown in

FIG. 4. The image in FIG. 6 shows that the perpendicular cylinders extend through relatively thick films with no wetting layer.

### EXAMPLE 2

### Self-Assembly of Cylinder-Forming PS-b-PLA on a Patterned Surface

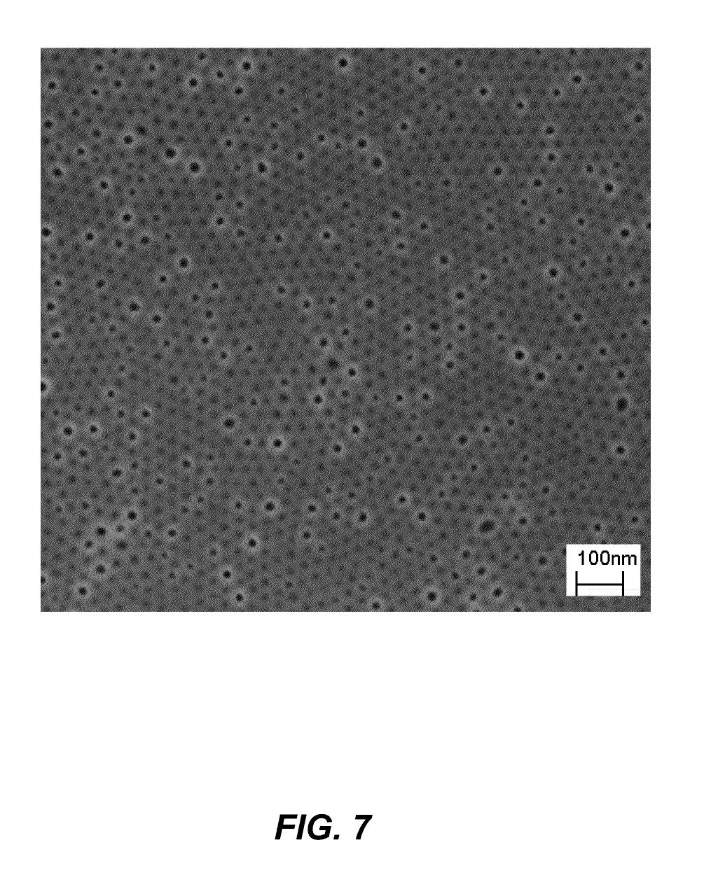

A pattern substrate was prepared by molecular transfer printing of PS-b-PMMA (46K-21K) blend films. The substrate was patterned with a hexagonal array of PMMA spots in a PS matrix, with a Lₛ of about 31 nm. A PS-b-PLA (Mₙ=21K-9K; Lₒ of about 29.9 nm) was deposited on the pattern and annealed at 190° C. for 24 hr. The film thickness was about 30 nm. The film assembled into perpendicular cylinders of PLA in a matrix of PS, with the arrangement indicating that the cylinders followed the underlying pattern. FIG. 7 shows the SEM image of the assembled film. The large dark spots may be defects caused by thermal degradation.

### EXAMPLE 3

### Self-Assembly of Lamella-Forming PS-b-PLA on Homogenous Brushes

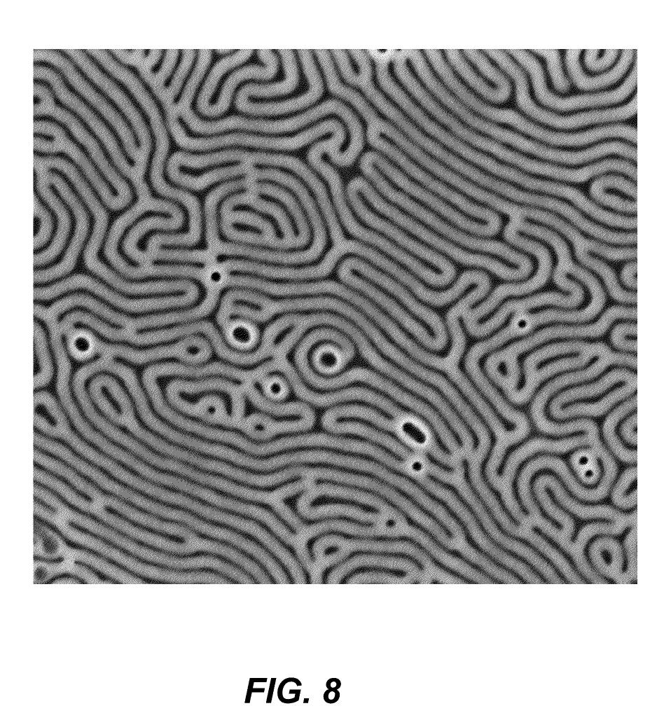

A PS-b-PLA BCP (Mₙ=21K PS−22K PLA; Lₒ of about 41 nm) film was deposited on a surface of PS-r-PMMA (60% styrene/40% methyl methacrylate) random copolymer brushes. The BCP was thermally annealed at 190° C. for 12 hrs. Film thickness was about 30 nm. FIG. 8 is a close-up SEM image of the assembled film. The PS-b-PLA film assembled into perpendicular lamella of PLA and PS over small areas. No wetting layer was observed, with the lamella extending through the entire film thickness of 30 nm. This indicates that thermal annealing of PS-b-PLA BCPs can be used to form lamellar domains perpendicular domains on a non-preferential surfaces without a wetting layer at the free surface.

### EXAMPLE 4

### Self-Assembly of Lamella-Forming PS-b-PLA on Heterogenous Brushes

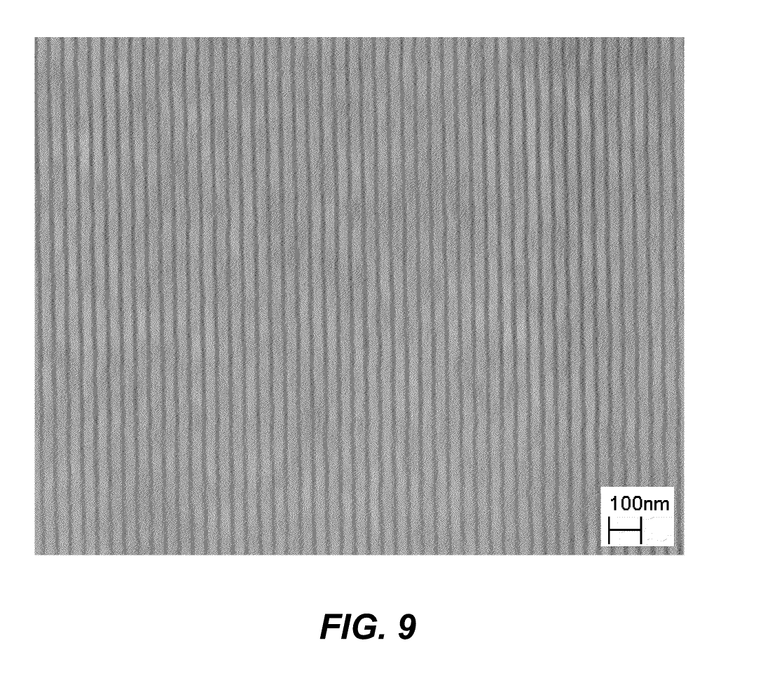

A substrate was patterned by EUV interference lithography, to form a pattern of alternating stripes having a Lₛ of 42.5 nm. A PS-b-PLA (Mₙ=21K-22K; Lₒ of about 41 nm) film was deposited on the pattern and annealed at 190° C. for 24 hr. The film thickness was about 40 nm. FIG. 9 is a SEM image of the assembled film. The film assembled into perpendicular lamellae registered on the underlying pattern. No wetting layer was observed.

Applications

Applications include pattern transfer as well as functionalizing one or more domains of the assembled block copolymer structure. Applications included nanolithography for semiconductor devices, fabrication of cell-based assays, nanoprinting, photovoltaic cells, and surface-conduction electron-emitter displays. In certain embodiments, patterned media and methods for fabricating pattern media are provided. The methods described herein may be used to generate the patterns of dots, lines or other patterns for patterned media. According to various embodiments, the resulting block copolymer films, nanoimprint templates, and patterned media disks are provided. In certain embodiments, a nanoimprint template is generated. A nanoimprint template is a substrate with a topographic pattern which is intended to be replicated on the surface of another substrate. There are several types of nanoimprinting processes. For UV-cure nanoimprinting, the template is a UV-transparent substrate (for example, made of quartz) with etched topographic features on one side. The patterned side of the template is brought into contact with a thin film of UV-curable liquid nanoimprint resist on the substrate to which the pattern is intended to be transferred. The liquid conforms to the topographic features on the template, and after a brief UV exposure, the liquid is cured to become a solid. After curing, the template is removed, leaving the solid resist with the replicated inverse topographic features on the second substrate. Thermal nanoimprinting is similar, except that instead of UV-light curing a liquid resist, heat is used to temporarily melt a solid resist to allow flow of the resist to conform with topographic features on the template; alternatively, heat can be used to cure a liquid resist to change it to a solid. For both approaches, the solid resist pattern is then used in subsequent pattern transfer steps to transfer the pattern to the substrate (or the resist may be used directly as a functional surface itself). The nanoimprint template may be generated by selectively removing one phase of the block copolymer pattern and replicating the topography of the remaining polymer material with a molding or nanoimprinting process. In certain embodiments, the nanoimprint template may be generated with one or more additional pattern transfer operations. A discussion of using an assembled BCP film to generate a nanoimprint template for patterned media applications is discussed, for example, in above-referenced US 2009-0196488, titled “Density Multiplication And Improved Lithography By Directed Block Copolymer Assembly.”

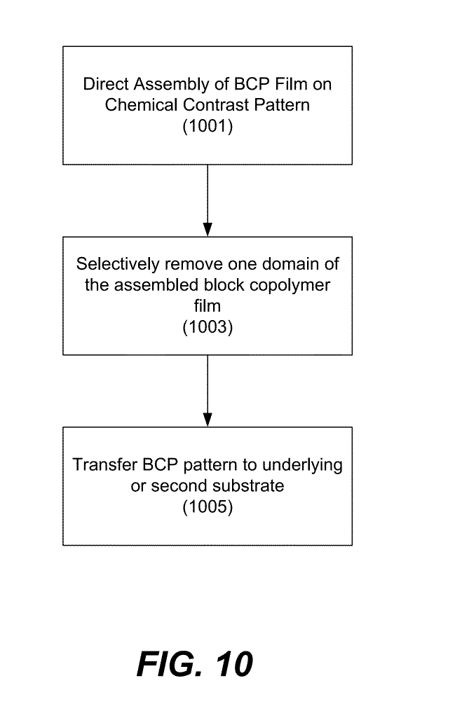

FIG. 10 is a process flow diagram illustrating operations in creating and using a BCP according to certain embodiments. First, a block copolymer film is directed to assemble on a pattered substrate (1001). This is done in accordance with the methods described above. One of the domains of the block copolymer film is then removed, e.g., by an oxygen plasma, thereby creating raised or recessed features (1003). Other methods of removing a domain include UV degradation. PLA can be removed by hydrolysis. The topographic pattern is then transferred to a substrate (1005). According to various embodiments, the pattern may be transferred by using the remaining polymer material as an etch mask for creating topography in the underlying substrate, or by replicating the topography in a second substrate, for example, by using a molding or nanoimprinting process.

The resulting structure can then be replicated by nanoimprinting, for example to create patterned media. The flow diagram shown in FIG. 10 is just an example of a process. In certain embodiments, the structure created by selective removal of one of the polymer phases in 1003 may be used as a template, e.g., after treating or functionalizing the remaining phase.

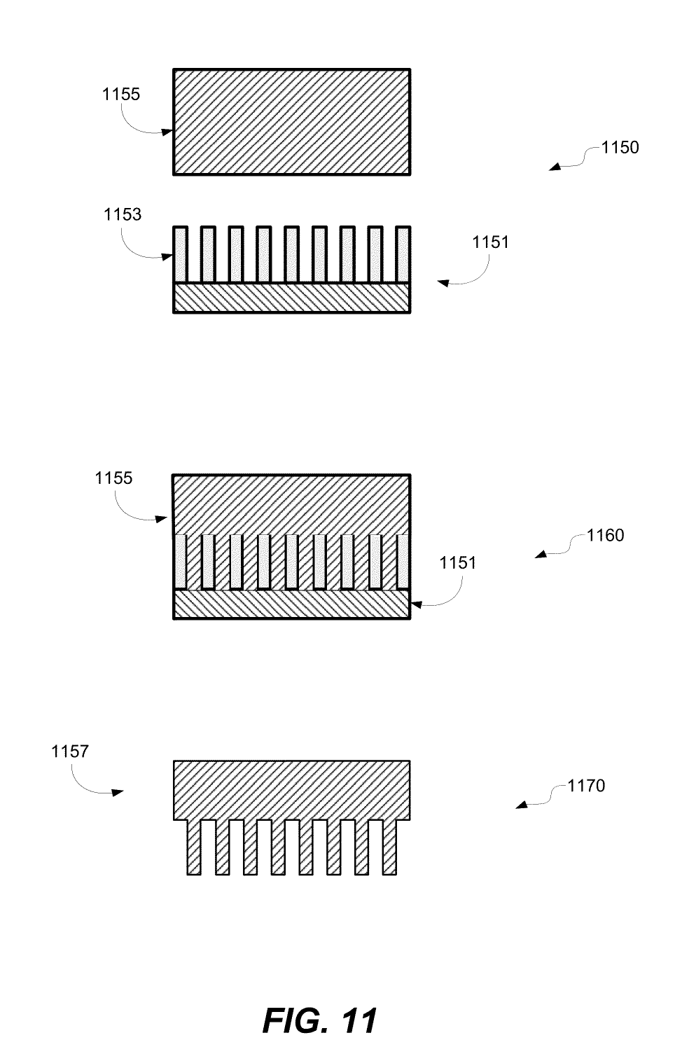

FIG. 11 illustrates an example of a nanoimprint process using a template according to various embodiments. First, at 1150, a cross-section of a nanoimprint template 1151 having features 1153 is shown. (Note that the features 1153 are raised; alternatively the recesses between these raised pillars or cylinders may be considered features). A second substrate to which the patterned is to be transferred is shown at 1155. According to various embodiments, template 1151 may be a block copolymer film after selective removal of one phase, or may have been generated as described above in operation 1005 of FIG. 10. Similarly, second substrate 1155 may be a disk to be patterned for data storage or an intermediate component in generating such as disk. In certain embodiments, a layer of resist (e.g., a UV-curable liquid resist) is on the substrate 1155.

At 1160, the second substrate 1155 is brought into contact with template 1151, thereby replicating the topography of the template. For example, a liquid resist on substrate 1155 conforms to the topographic features on the template, and after a brief UV exposure, the liquid is cured to become a solid. The resulting patterned structure 1357 is shown at 1170.

In many patterned media applications, the patterned media is in the form of a circular disk, e.g., to be used in hard disk drives. The methods described herein may be used to generate the patterns of dots, lines or other patterns for patterned media. According to various embodiments, the resulting block copolymer films, nanoimprint templates, and patterned media disks are provided. In many patterned media applications, the patterned media is in the form of a circular disk, e.g., to be used in hard disk drives. These disks typically have inner diameters as small as 7 mm and outer diameters as large as 95 mm. The patterned features may be arranged in circular tracks around a center point. The block copolymer films used to fabricate these patterned media disks are also circular. In certain embodiments, the patterns on the original substrate, the assembled block copolymer films, the nanoimprint templates and the pattern media are divided into zones, with the angular spacing of the features (dots) within a zone constant. The nominally hexagonal pattern of dots is relaxed near the center of each radial zone. Within each zone or circumferential band, however, the pattern becomes compressed in the circumferential (but not radial) direction moving in toward the center of the disk. Likewise, within each zone, the pattern is circumferentially stretched moving outward toward the edge of the disk away from the center.

Each zone is made up of dots on circular tracks (so that a head can fly along a track circumferentially to read or write data). According to various embodiments, the stretching and compression is done in a way such that the number of dots all the way around a single track is constant. This means that the dots are arranged with constant angular spacing along a track, when viewing rotationally with respect to the center of the disk. This also means that the circumferential spacing of the dots within a single zone scales with the radius. Thus, the amount of stretching and compressing needed corresponds to the radial width of a zone. The spacing between tracks is kept constant; only the circumferential direction gets stretched or compressed.

Each zone has its own constant angular spacing of dots, and that spacing is chosen so that the self-assembled pattern is in the relaxed state near the center of the zone. For example, if we are using block copolymers with a natural period of 39 nm, then the spacing of dots in the center of each zone is 39 nm, and is more compressed (e.g., 36 nm spacing) along a track at the inner edge of a zone, and stretched (e.g., 42 nm spacing) at the outer edge of a zone. For self-assembly of block copolymers, the precursor e-beam pattern can be written with this zone-wise stretching and compression. If each zone is not too wide, the block copolymer forms a commensurate pattern on the precursor pattern, following the compression and stretching that has been written by the e-beam into the precursor pattern. As described above, the block copolymer film assembly is fairly tolerant, allowing the distance between dots on the chemical pattern to vary by +/−0.1Lₒ. This allows a block copolymer film deposited on a zone to form a commensurate pattern. According to various embodiments, the width of the zone may be on the order of 1 mm, though this can vary depending on the pattern and the block copolymer used.

Although the foregoing invention has been described in some detail for purposes of clarity of understanding, it will be apparent that certain changes and modifications may be practiced within the scope of the invention. It should be noted that there are many alternative ways of implementing both the process and compositions of the present invention. Accordingly, the present embodiments are to be considered as illustrative and not restrictive, and the invention is not to be limited to the details given herein.

1. A method comprising:
depositing a material comprising a block copolymer on a substrate pattern; and
ordering the material to form a thin film including phase-separated microdomains that are oriented perpendicularly to the substrate and extend through the thickness of the thin film, wherein the block copolymer includes polyglycolic acid (PGA) or a derivative thereof

2. The method of claim 1, wherein the block copolymer includes a PGA derivative selected from poly(hydroxyisobutyr c acid) (PIBA) and polylactic acid (PLA).

3. The method of claim 1, wherein the block copolymer further includes polystyrene (PS) or a derivative thereof

4. The method of claim 1, wherein the block copolymer further includes a polyacrylateor a derivative thereof

5. The method of claim 1, wherein one or more of the microdomains has a domain size of less than about 20 nm.

6. The method of claim 1, wherein one or more of the microdomains has a domain size of less than about 10 nm.

7. The method of claim 1, wherein the block copolymer is a triblock copolymer.

8. The method of claim 1, wherein the block copolymer is selected from the group consisting of PS-PLA, PS-PLA-PS, PMMA-PLA, PMMA- PLA-PMMA, PLA-PS-PLA, PS-PLA-PMMA, PS-PGA, PS-PGA-PS, PMMA-PGA, PMMA-PGA-PMMA, PGA-PS-PGA, PS-PGA-PMMA, PS-PIBA, PS-PIBA-PS, PMMA-PIBA, PMMA-PIBA-PMMA, PIBA-PS-PIBA, and PS-PIBA-PMMA.

9. The method of claim 1, wherein the material further comprises a homopolymer.

10. The method of claim 1, wherein ordering the material comprises thermally annealing the material.

11. The method of claim 1, wherein the microdomains are registered with the substrate pattern.

12. The method of claim 1, wherein the correspondence of the microdomains to the substrate pattern is 2:1 or greater.

13. A method comprising:
providing a thin film on a substrate, the thin film including phase-separated microdomains oriented perpendicularly to the substrate and extending through the thickness of the thin film, wherein the block copolymer includes a first block comprising PGA or a derivative thereof; and
removing the first block.

14. A thin film structure comprising phase-separated microdomains of a block copolymer, the microdomains oriented perpendicularly to an underlying substrate and extending through the thickness of the thin film, wherein the block copolymer comprises polyglycolic acid (PGA) or a derivative thereof.

15. The thin film structure of claim 14, wherein the block copolymer includes a PGA derivative selected from poly(hydroxyisobutyric acid) (PIRA) and polylactic acid (PLA).

16. The thin film structure of claim 14, wherein the substrate includes a surface pattern.

17. The thin film structure of claim 14, wherein the phase-separated microdomains domains are registered with the surface pattern.

18. The thin film structure of claim 14, wherein at least one microdomain has a sub-20 nm size.

19. The thin film structure of claim 14, wherein at least one microdomain has a sub-10 nm size.

20. The thin film structure of claim 14, wherein the block copolymer further includes polystyrene (PS), polymethyl methacrylate (PMMA), or a derivative thereof.
